(19) United States
(12) Patent Application Publication
(10) Pub. No.: US 2008/0080947 A1
(43) Pub. Date: Apr. 3, 2008

(54) Ballistic resistant jacket bolt

(76) Inventor: Steve McGrade, Beaumont, TX (US)

Correspondence Address: Eric Adams;One Allen Center, Suite 1200, 500 Dallas, Houston, TX, 77002, US

(21) Appl. No.: 11/447,000

(22) Filed: Jun. 5, 2006

Related U.S. Application Data
(60) Provisional application No. 60/757,651, filed on Jan. 10, 2006.

(51) Int. Cl. F16B 21/00

(52) U.S. Cl. 411/338

(57) ABSTRACT

A ballistic resistant bolt to be used in securing straps on a military combat helmet. The bolt includes a single slot within a round bolt head for adjustment in the field if desired. The bolt also has a shaft bearing internal threads for strength. Thus provided, the bolt is resistant to damage from ballistic projectiles. The unique combination of design elements provides the strength and deflective properties required for ballistic resistance in a bolt this size. The bolt is constructed of stainless steel, but other suitable, ballistic resistant material can also be used.

### CROSS REFERENCE TO RELATED APPLICATION

This application claims the benefit of priority of U.S. Provisional Application Ser. No. 60/757,651 filed Jan. 10, 2006. The disclosure of the above application is incorporated herein by reference in its entirety.

### BACKGROUND OF THE INVENTION

This invention generally relates to fasteners, specifically to a ballistic resistant bolt.

Military combat helmets are currently made out of Kevlar®. These helmets are made to be ballistic resistant. A consistent, unsolvable problem has been the design of a ballistic resistant bolt which extends from the outside of the helmet to the inside of the helmet to secure the helmet's straps. To solve this problem, an adjustable, lightweight bolt that would not fracture when hit with ballistic projectiles is needed. This problem has been solved by the present invention.

Although there has existed fastener systems to be used in conjunction with ballistic proof and armored panels, such as disclosed in U.S. Pat. No. 5,438,908 and U.S. Pat. No. 5,600,084, there has never existed a fastener wherein the bolt itself was ballistic resistant until now. U.S. Pat. No. 6,854,921 discloses and claims a ballistic cap nut which is distinguishable from the ballistic resistant bolt disclosed and claimed herein.

Previous to this invention, there were several attempts made to determine what commercially available fasteners would provide the ballistic resistant characteristic needed for a military combat helmet. All efforts previous to this invention failed.

### SUMMARY OF THE INVENTION

The present invention is directed to a ballistic resistant bolt used in a fastener system for securing the straps of a military combat helmet. As will be described, the fastener is a uniquely designed bolt which extends from the outside of the military combat helmet to the inside of the helmet. The design of the bolt is sufficient to provide a ballistic resistant surface. In one preferred form, the ballistic resistant bolt comprises a bolt head with a slot that allows the bolt to be adjusted in the field.

Further areas of applicability of the present invention will become apparent from the detailed description provided hereinafter. It should be understood that the detailed description and specific examples are intended for purposes of illustration only and are not intended to limit the scope of the invention.

### DRAWINGS

FIG. 1 shows the preferred embodiment 6 of my invention in side elevation with the single slot 8 contained within the round bolt head 10.

FIG. 2 is a top view of the bolt head 10 of FIG. 1 with the single slot 8 embedded within the bolt head 10.

FIG. 3 is the exemplary helmet generally indicated by reference number 26.

FIG. 4 is a jacket bolt assembly using the preferred embodiment 6 wherein the helmet 26 and chin strap 28 (shown in cross section for clarity) are secured together.

### DESCRIPTION

The following description of the preferred embodiment is merely exemplary in nature and is in no way intended to limit the invention, its applications, or uses.

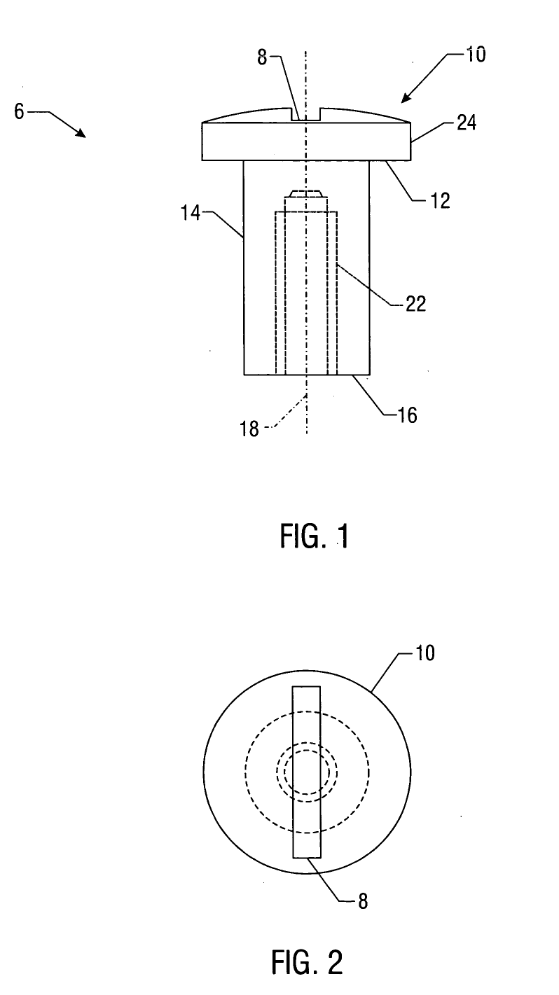

FIG. 1 shows a preferred embodiment 6 of my invention in side elevation with a single slot 8 contained within a round bolt head 10. Extending from the underside 12 of the bolt head 10 is an elongated shaft 14 that terminates at an end surface 16 distal from the bolt head 10. The shaft 14 has a common central axis 18 with an apex of the round bolt head 10. The length of the elongated shaft 14 bears internal threads 22 therein.

With further reference to FIG. 1, the single slot 8 is located along the diameter of the bolt head 10. The slot 8 extends equidistant from the apex of the bolt head 10. The length of slot 8 is less than the diameter of the bolt head 10. The center of the slot 8 is located at the apex of the bolt head 10. The slot 8 extends to a maximum depth of 0.029 inches across the entire length of the slot 8 in the preferred embodiment 6. Alternative embodiments of my invention with no slot are also possible.

With further reference to FIG. 1, the bolt head 10 slopes uniformly downward from the apex towards a top circumference edge 24 of the bolt head 10. After the slope of the bolt head 10 terminates, the bolt head 10 extends straight in the direction of the end surface 16 for a distance of 0.039 inches in the preferred embodiment 6. The diameter of the bolt head 10 at its widest is 0.438 inches in the preferred embodiment 6. Further, depending on a specific application or need, the exact dimensions of the bolt head 10 may be altered.

With further reference to FIG. 1, the shaft 14 extends from the underside 12 of the bolt head 10 to the end surface 16 for a distance of 0.500 inches. The diameter of the shaft 14 is 0.265 inches in the preferred embodiment 6. The internal threads 22 within the shaft 14 are 8-32 threads with a ⅜ inch thread depth in the preferred embodiment 6. Alternative embodiments of my invention with internal threads 22 of 10-24 threads are also possible. Further, depending on a specific application or need, the exact dimensions of the shaft 14 and internal threads 22 may be altered.

FIG. 2 is a top view of the bolt head 10 of FIG. 1 with the single slot 8 embedded within the bolt head 10. The slot 8 has a uniform width of 0.057 inches in the preferred embodiment 6. Further, depending on a specific application or need, the exact dimensions of the slot 8 may be altered.

Preferably, the jacket bolt is constructed of stainless steel, but other suitable, ballistic resistant materials could also be used. The jacket bolt can be readily machined into the preferred embodiment 6 by those skilled in such practices.

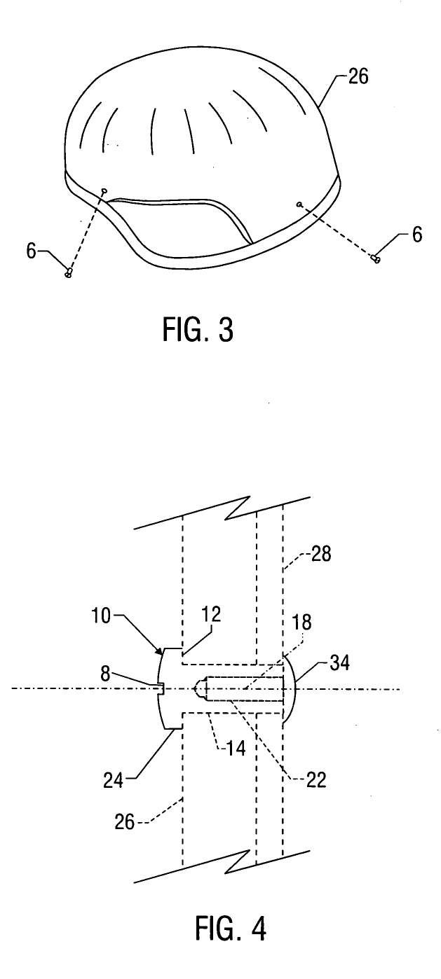

FIG. 3 is an exemplary helmet generally indicated by reference number 26. For ballistic resistant applications, helmet 26 may consist of ballistic resistant materials. Generally, helmet 26 includes chin strap 28 (not shown in this figure) to secure the helmet 26 in place. A plurality of jacket bolts each formed in accordance with the preferred embodiment 6 of my invention are used to secure the chin strap 28 to the helmet 26.

A jacket bolt assembly is shown in FIG. 4 using the preferred embodiment 6 wherein the helmet 26 and chin strap 28 (shown in cross section for clarity) are secured together. An aperture of the helmet 26 and an aperture of the chin strap 28 are of sufficient diameter to allow the preferred embodiment 6 to be introduced through both apertures. Furthermore, the preferred embodiment 6 interfaces with a fastening element 34 using the internal threads 22 of the preferred embodiment 6.

The following paragraph describes the operation of my invention.

During assembly, the helmet 26 and chin strap 28 are positioned such that apertures are aligned. The jacket bolt extends through both apertures. The preferred embodiment 6 is secured in that position using the fastening element 34. The preferred embodiment 6 may be adjusted using the slot 8 in the preferred embodiment 6. The bolt head 10 thickness is sufficient to withstand an impact from a projectile impacting jacket bolt at any angle as well as a projectile impacting the apex of the bolt head 10.

The present invention thus provides a unique fastener assembly for use in applications that require ballistic resistant. While it is especially well adapted for use with helmets, it will be appreciated that the fastener assembly of the present invention is readily adapted for use with little or no modification in virtually any form of mobile platform where security and ballistic resistant are important considerations. The fastener assembly of the present invention is further not limited to use with only mobile platforms, but may also be implemented in virtually any stationary structure where ballistic resistant is a concern.

The description of the invention is merely exemplary in nature and, thus, variations that do not depart from the gist of the invention are intended to be within the scope of the invention. Such variations are not to be regarded as a departure from the spirit and scope of the invention.

### CONCLUSION, RAMIFICATIONS AND SCOPE

Thus, the reader will see that the ballistic resistant bolt of the invention provides a lightweight bolt that is perfectly suited for the military combat helmet.

While the above descriptions contain many specificities, these should not be construed on the scope of the invention, but rather as an exemplification of one preferred embodiment thereof. Many other variations are possible. For example, slight changes in the dimensions of the bolt are possible while retaining the ballistic nature of the bolt. Another possible embodiment of the invention is one in which there is no slot for adjustment in the bolt head.

Accordingly, the scope of the invention should be determined not by the embodiment(s) illustrated, but by the appended claims and their legal equivalents.

What is claimed is:

1. A ballistic resistant jacket bolt comprising:
a round bolt head sloping uniformly from an apex to a top circumference edge, said bolt head having a diameter of between 0.435 inches and 0.440 inches and having a straight edge of between 0.039 inches and 0.044 inches;
a shaft extending from an underside of said bolt head to an end surface distal from said bolt head with a minimum length of 0.45 inches, said shaft having a common central axis with said bolt head and a diameter of between 0.260 inches and 0.270 inches; and
an internal threads portion within said shaft extending a distance of 0.38 inches, said internal threads having 8-32 threads with a 0.375 inch thread depth.

2. The ballistic resistant jacket bolt of claim 1, wherein said bolt head contains a slot along a diameter of said bolt head equidistant from an apex of said bolt head and having a length less than a said diameter of said bolt head.

3. The apparatus of claim 2, wherein said slot has a maximum depth of 0.40 inches.

4. The apparatus of claim 2, wherein said slot has a maximum width of 0.062 inches.
